(19) United States
(12) Patent Application Publication
(10) Pub. No.: US 2004/0074345 A1
(43) Pub. Date: Apr. 22, 2004

(54) Adjustable wrench capable of microadjustment of movable jaw thereof

(76) Inventor: Chun-Nuan Huang, Ta Li City (TW)

Correspondence Address: LAW OFFICE OF LIAUH & ASSOC., 4224 WAIALAE AVE, STE 5-388, HONOLULU, HI, 96816

(21) Appl. No.: 10/274,701

(22) Filed: Oct. 18, 2002

(51) Int. Cl. B25B 13/22

(52) U.S. Cl. 81/142

(57) ABSTRACT

An adjustable wrench comprises a first handle piece, a second handle piece, an assembly block fastened between the first handle piece and the second handle piece, a rack, and a movable jaw. The first handle piece is provided with a fixed jaw. The block is provided at a longitudinal end with an assembly slot in which the rack is movably disposed such that the rack is urged by an urging rod in conjunction with a compression spring, and that a toothed portion of the rack is engaged, with a toothed portion of a slide block of the movable jaw, thereby enabling the movable jaw to be microadjusted.

### FILED OF THE INVENTION

The present invention relates generally to an adjustable wrench, and more particularly to an adjustable wrench which is provided with means to facilitate the microadjusting of a movable jaw thereof so as to enhance the maneuverability of the adjustable wrench.

### BACKGROUND OF THE INVENTION

As shown in FIG. 1, a prior art wrench has a handle 1 which is provided at one end with an opening 2 which is formed and defined by two jaws 3a and 3b for holding and turning a nut, bolt, or pipe. In light of the opening 2 being fixed in dimension, the prior art wrench is limited in use. In addition, the prior art wrench can not be maneuvered with ease and speed in a confined space.

As shown in FIG. 2, an adjustable wrench of the prior has a handle 4 which is provided at one end with a fixed jaw 5 and a movable jaw 7 opposite to the fixed jaw 5. The handle 4 is further provided in proximity of the one end with a plurality of adjustment threaded rods 6, which are meshed with a toothed portion 8 for turning the threaded rods 6 so as to actuate the movable jaw 7 to displace to facilitate the holding and the turning of nuts, bolts, pipes, etc., in conjunction with the fixed jaw 5. The prior art adjustable wrench as described above can not be easily maneuvered in a confined space, especially at such time when the handle 4 is obstructed by a fixed object.

### SUMMARY OF THE INVENTION

The primary objective of the present invention is to provide an adjustable wrench with a movable jaw which can be microadjusted so as to enhance the maneuverability of the adjustable wrench.

In keeping with the principle of the present invention, the foregoing objective of the present invention is attained by an adjustable wrench comprising a first handle piece and a second handle piece. The first handle piece is provided with an assembly block which is fastened thereto and is provided at one end with an assembly slot contiguous to a fixed jaw extending form the one end of the first handle piece. The assembly slot is used to accommodate a rack. Located between the fixed jaw and the assembly block is a slide space in which a slide block of a movable jaw is slidably disposed such that a toothed portion of the underside of the slide block of the movable jaw meshes a toothed portion of the rack. The rack is actuated by the movable jaw to displace at such time when the movable jaw is urged by the corner of a bolt and the like, thereby resulting in an adjustment in dimension of an opening formed between the fixed jaw and the movable jaw.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of a prior art wrench.

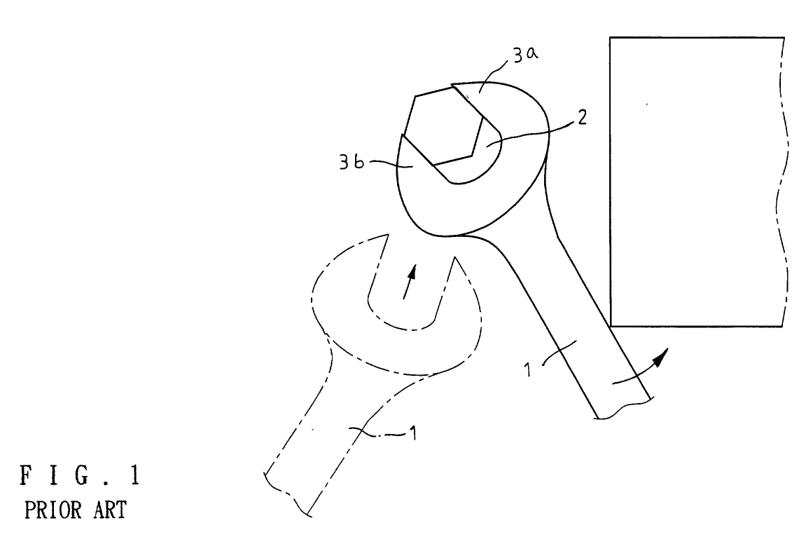

FIG. 2 shows a schematic view of an adjustable wrench of the prior art.

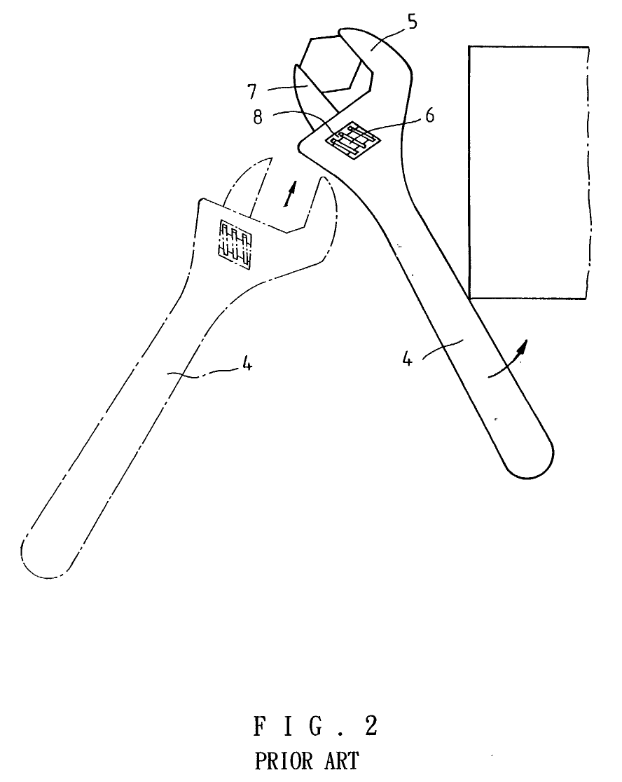

FIG. 3 shows an exploded view of the preferred embodiment of the present invention.

FIG. 4 shows a partial exploded view of the preferred embodiment of the present invention.

FIG. 5 shows a perspective view of the preferred embodiment of the present invention in combination.

FIG. 6 shows a side schematic view of the preferred embodiment of the present invention.

FIG. 7 shows a schematic view of the preferred embodiment of the present invention at work.

FIG. 8 shows a schematic view of the preferred embodiment of the present invention in action.

FIG. 9 shows a schematic view of a microadjustment of the preferred embodiment of the present invention.

FIG. 10 shows another schematic view of a microadjustment of the preferred embodiment of the present invention.

FIG. 11 shows a schematic view of the preferred embodiment of the present invention in action.

### DETAILED DESCRIPTION OF THE PREFERRED EMBODIMENT

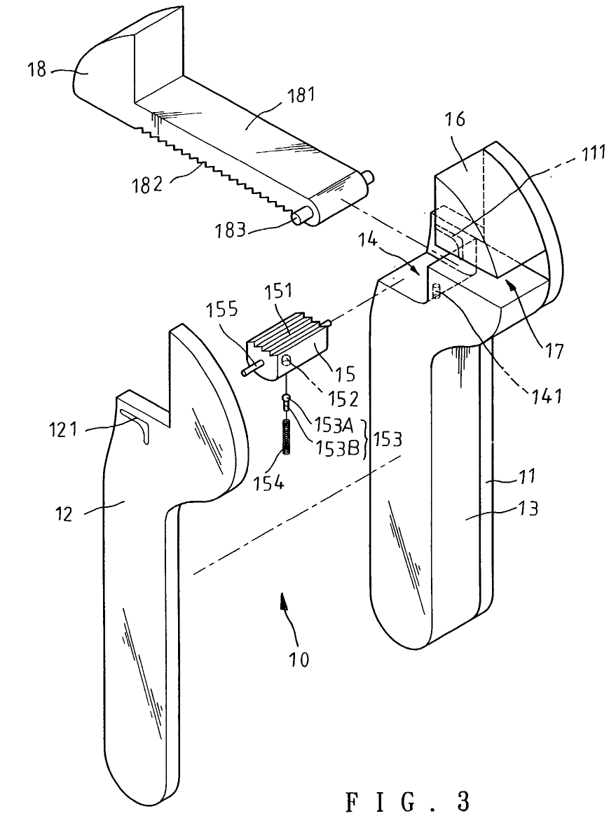

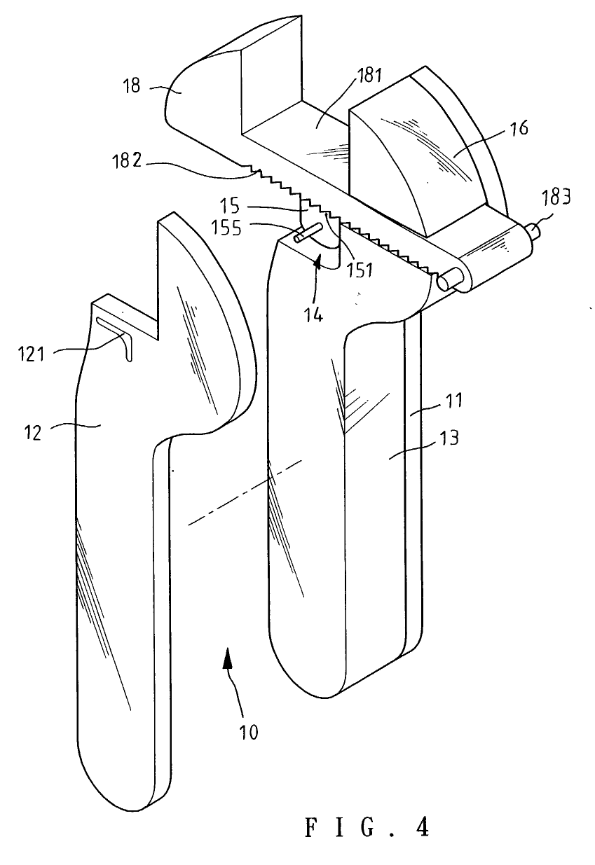

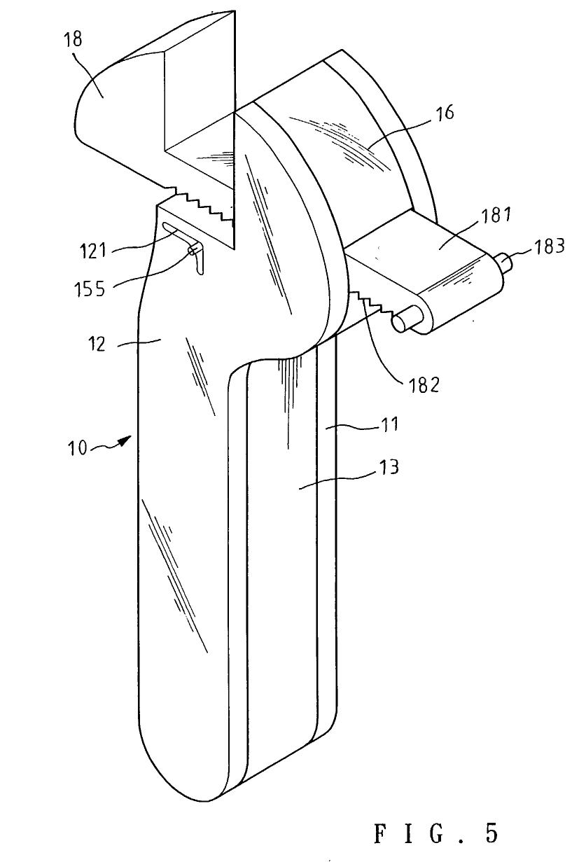

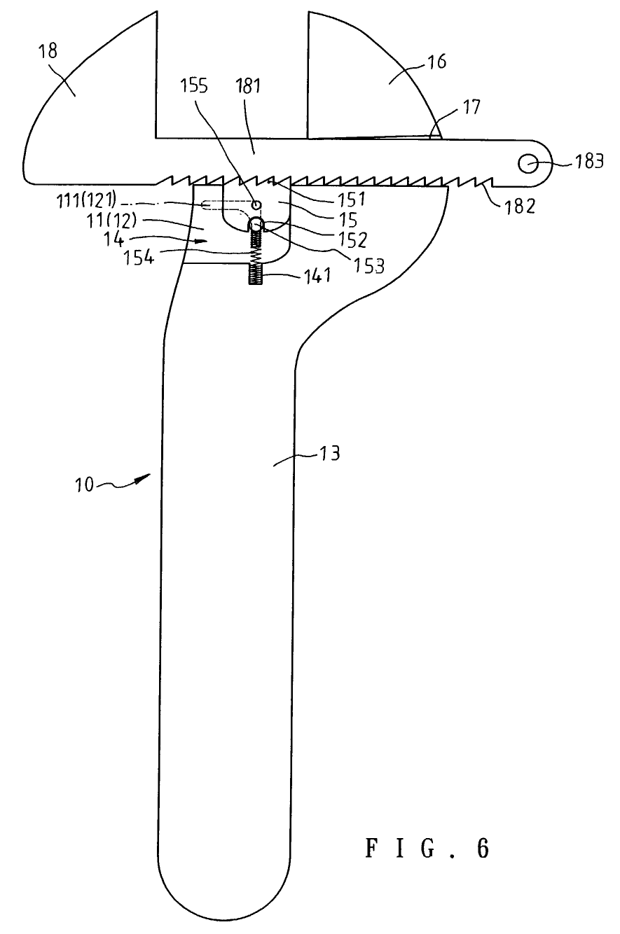

As shows in FIGS. 3-6, an adjustable wrench 10 embodied in the present invention comprises a first handle piece 11, a second handle piece 12, an assembly block 13 corresponding in shape to the first handle piece 11, a rack 15, and a movable jaw 18.

The first handle piece 11 has a predetermined length and is provided at a longitudinal end with a fixed jaw 16 extending therefrom, and a first through slot 111 located under the fixed jaw 16.

The second handle piece 12 is corresponding in size and shape to the first handle piece 11 and is provided at a longitudinal end with a second through slot 121 corresponding to the first through slot 111 of the first handle piece 11.

The assembly block 13 is fused with the first handle piece 11 and is provided at a longitudinal end with an assembly slot 14 which is in turn provided in the bottom wall with a locating cavity 141. Located between the longitudinal end of the assembly block 13 and the underside of the fixed jaw 16 is a slide space 17. The second handle piece 12 is joined with the assembly block 13.

The rack 15 is provided in the upper side with a toothed portion 151, and in the underside with a spherical cavity 152 in which an urging rod 153 with a spherical head 153A is movably disposed. The urging rod 153 has a shank 153B which is fitted into a spring 154, with one end of the spring 154 being stopped by the head 153A of the urging rod 153, and with other end of the spring 154 being located in the locating cavity 141 of the assembly slot 14 of the block 13. The rack 15 is further provided with a press rod 155 which is disposed in the interior of the rack 15 such that both ends of the press rod 155 are extended out of two longitudinal ends of the rack 15. The rack 15 is movably disposed in the assembly slot 14 of the block 13 such that the rack 15 is urged by the urging rod 153 in conjunction with the spring 154, and that one end of the press rod 155 is put through the first through slot 111 of the first handle piece 11, and further that other end of the press rod 155 is put through the second through slot 121 of the second handle piece 12.

The movable jaw 18 has a slide block 181 which is provided in the underside with a toothed portion 182 engageable with the toothed portion 151 of the rack 15. The slide block 181 is provided at a free end with a confining rod 183 perpendicular to the longitudinal direction of the slide block 181. The slide block 181 is slidably disposed in the slide space 17 such that the toothed portion 182 of the slide block 181 meshes the toothed portion 151 of the rack 15, and that the movable jaw 18 is opposite in location to the fixed jaw 16, and further that the confining rod 183 is located in the outside of the slide space 17 for the purpose of confining the sliding of the slide block 181.

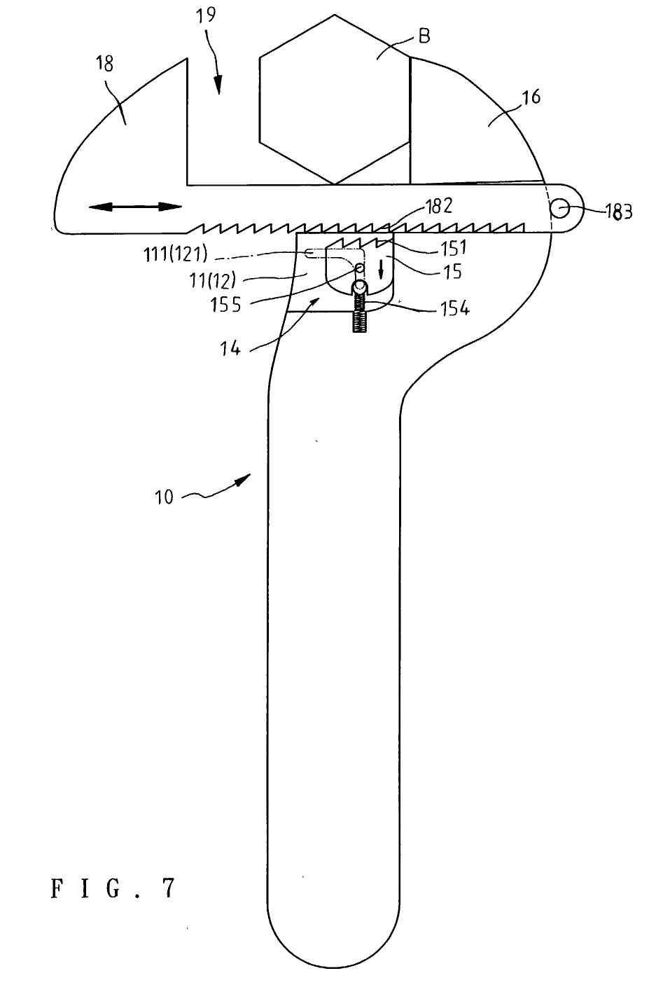

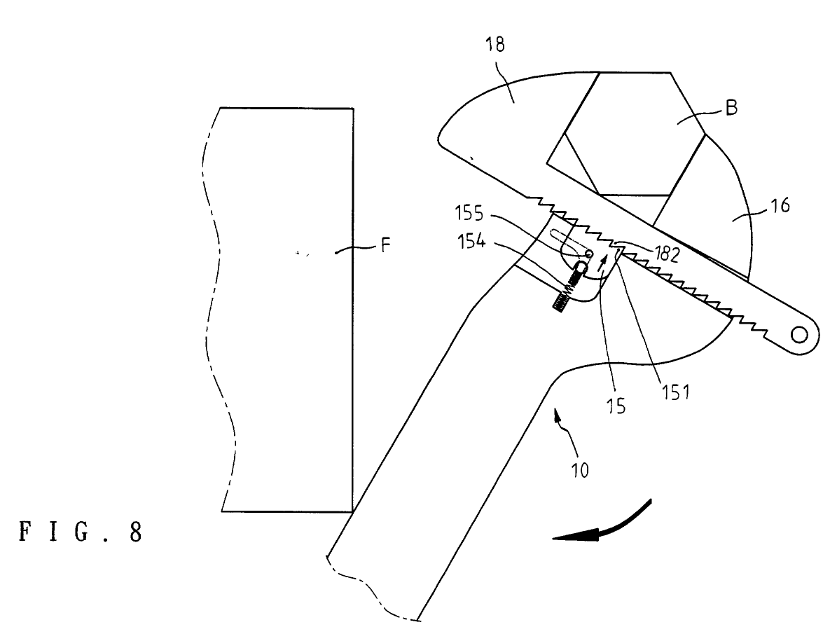

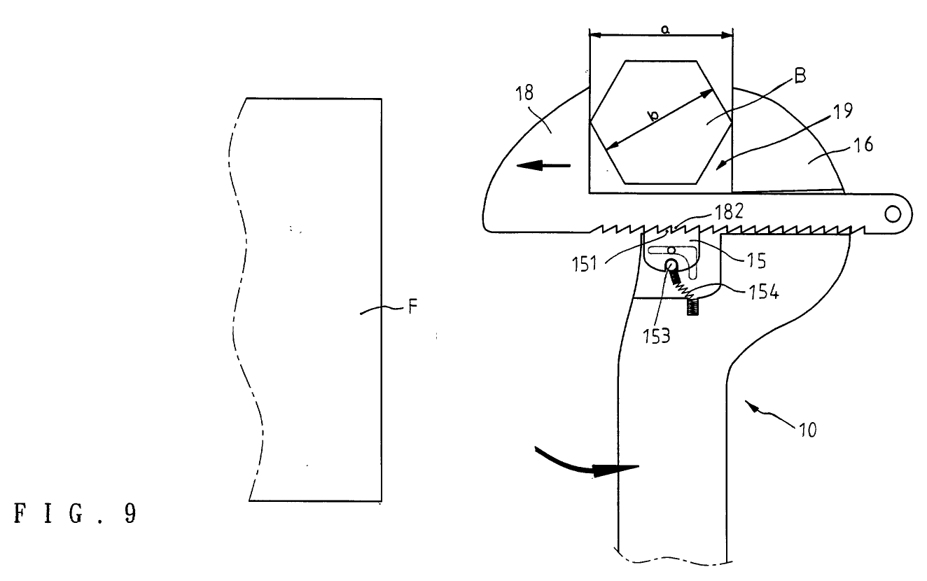

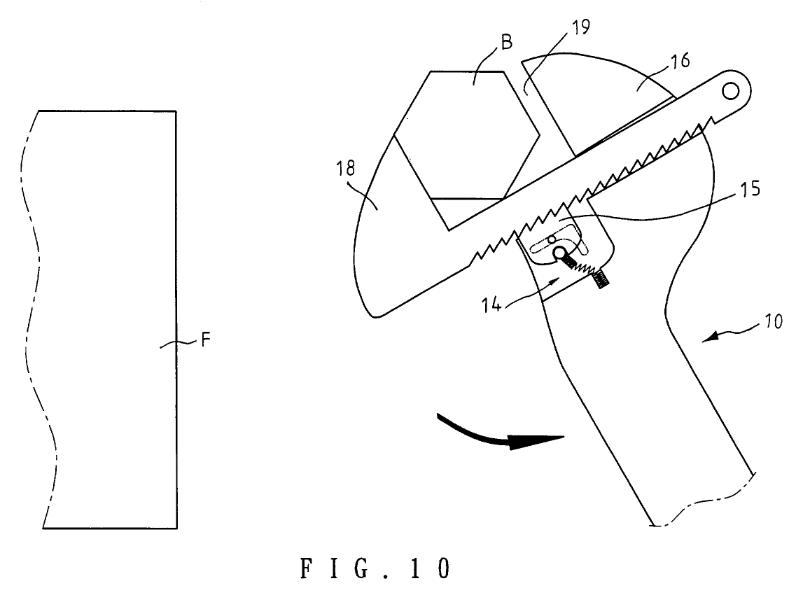

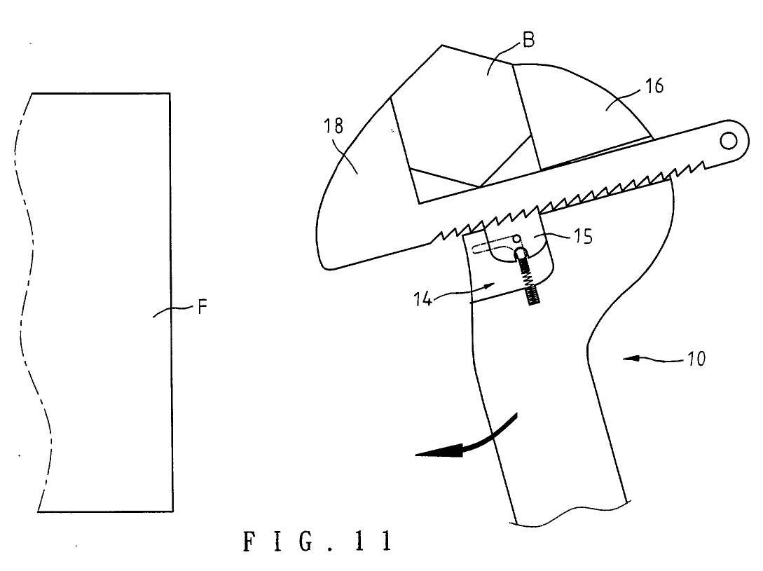

As illustrated in FIG. 7, an opening 19 is formed between the fixed jaw 16 and the movable jaw 18. In light of the opening 19 being too large to hole securely a bolt “B”, the rack 15 is pressed downward to cause both ends of the press rod 155 to displace respectively in the first through slot 111 of the first handle piece 11 and the second through slot 121 of the second handle piece 12. In the meantime, the spring 154 of the rack 15 is compressed, while the toothed portion 151 of the rack becomes disengaged with the toothed portion 182 of the movable jaw 18. The movable jaw 18 is then moved to join with the bolt “B”, as illustrated in FIG. 8. As soon as the rack 15 is relieved of the pressure exerting thereon, the rack 15 is forced by the spring force of the compression spring 154 to return to its original position, thereby resulting in engagement of the toothed portion 151 of the rack 15 with the toothed portion 182 of the slide block 181 of the movable jaw 18. In the event that the turning of the wrench 10 is obstructed by a fixed object “F”, as illustrated in FIG. 8, the wrench 10 is turned in reverse, as illustrated in FIG. 9 in which two diagonal angles of the bolt “B” are shown to be held by the fixed jaw 16 and the movable jaw 18. The two diagonal angles are separated by a distance “a”, which is greater than a distance “b” between two opposite sides of the bolt “B”, as shown in FIG. 9. Under such circumstances, the movable jaw 18 can be forced by one of the diagonal angles of the bolt “B” to move so as to actuate the rack 15 to move along, thereby causing the spring 154 to be pulled 10 and bent, as shown in FIG. 9. As a result, the urging rod 153 is tilted to keep urging the rack 15, so as to enable the toothed portion 151 of the rack 15 to remain in the state of meshing with the toothed portion 182 of the slide block 181 of the movable jaw 18. One side of the bolt “B” comes in contact with the movable jaw 18, as shown in FIG. 10 in which other side of the bolt “B” is shown to be parallel to and separated from the fixed jaw 16 by an interval. As the wrench 10 is turned clockwise, as shown in FIG. 11, both the urging rod 153 and the spring 154 are no longer tilted. As a result, the bolt “B” is securely held by the fixed jaw 16 and the movable jaw 18.

The embodiment of the present invention described above is to be regarded in all respects as being illustrative and nonrestrictive. Accordingly, the present invention may be embodied in other specific forms without deviating from the spirit thereof. The present invention is therefore to be limited only by the scope of the following claim.

What is claimed is:

1. An adjustable wrench comprising:
a first handle piece of a length and provided at one longitudinal end with a fixed jaw extending therefrom, and a first through slot located under said fixed jaw;
a second handle piece corresponding in length and shape to said first handle piece and provided at one longitudinal end with a second through slot corresponding to said first through slot of said first handle piece;
an assembly block fastened between said first handle piece and said second handle piece such that a slide space is formed between one longitudinal end of said assembly block and an underside of said fixed jaw of said first handle piece, said assembly block being provided in the one longitudinal end thereof with an assembly slot whereby said assembly slot is provided in a bottom wall with a locating cavity;
a rack provided in an upper side with a toothed portion, and in an underside with a locating cavity, an urging rod movably located at one end in said locating cavity, and a compression spring fitted over said urging rod, said rack further provided with a press rod which is disposed in an interior of said rack such that both ends of said press rod are extended out of two longitudinal ends of said rack whereby said rack is movably disposed in said assembly slot of said assembly block in such a manner that a bottom end of said compression spring is located in said locating cavity of said assembly slot of said assembly block, and that said rack is urged by said urging rod in conjunction with said compression spring, and further that one end of said press rod of said rack is movably received in said first through slot of said first handle piece, and further that other end of said press rod of said rack is movably received in said second through slot of said second handle piece; and
a movable jaw having a slide block, said slide block being provided in an underside with a toothed portion, and at a free end with a confining rod whereby said slide block is slidably disposed in said slide space such that said toothed portion of said slide block is engaged with said toothed portion of said rack, and that said movable jaw is opposite in location to said fixed jaw of said first handle piece, and further that said confining rod is located in the outside of said slide space.

2. The adjustable wrench as defined in claim 1, wherein said locating cavity of the underside of said rack is of a spherical construction; wherein said urging rod of said rack has a spherical head whereby said spherical head of said urging rod is movably located in said locating cavity of the underside of said rack.
